(19) United States
(12) Patent Application Publication
(10) Pub. No.: US 2026/0045813 A1
(43) Pub. Date: Feb. 12, 2026

(54) CHARGING MODULE AND BATTERY CHARGING CASE

(71) Applicant: Shenzhen Obuy Technology Co., Ltd, Shenzhen (CN)

(72) Inventors: QI YUAN, Shenzhen (CN); OU YANG, Shenzhen (CN); MANCHUN CAI, Shenzhen (CN); ZIYANG ZHOU, Shenzhen (CN)

(21) Appl. No.: 19/015,998

(22) Filed: Jan. 10, 2025

(30) Foreign Application Priority Data
Aug. 7, 2024 (CN) 202411074657.2

(51) Int. Cl. H02J 7/00; H01M 10/46

(52) U.S. Cl. CPC H02J 7/0045; H01M 10/46

(57) ABSTRACT

The present application discloses a charging module and a battery charging case, and the charging module is used for the battery charging case, and the charging module includes a charging compartment, a charging clamping structure, and a first drive assembly; the charging compartment includes a compartment body and a first bracket, and the first bracket is installed in the chamber of the compartment body and includes a battery installation through slot for accommodating the batteries to be charged; the charging clamping structure is installed on the first bracket corresponding to the battery installation through slot, and the first drive assembly is drivingly connected to the charging clamping structure.

### CROSS-REFERENCE TO RELATED APPLICATIONS

This application claims priority to Chinese Patent Application No. 202411074657.2, filed on Aug. 7, 2024, which is hereby incorporated by reference in its entirety.

### TECHNICAL FIELD

The present application relates to the field of battery charging technology, particularly to a charging module and a battery charging case.

### BACKGROUND

In related technology, the battery charging case comprises a charging module used to charge the batteries to be charged. However, when the charging module is charging the batteries to be charged, the batteries to be charged may become loose due to external factors such as the shaking of battery charging case, resulting in the failure of charging module to effectively charge the batteries to be charged and therefore, how to make the charging module to effectively charge the batteries to be charged has become an urgent issue to be solved.

### SUMMARY

The embodiment of the present application provides a charging module and a battery charging case, which can solve the problem in related technologies that the charging module fails to effectively charge the loosening batteries to be charged because of the shaking of battery charging case.

In the first aspect, the embodiment of present application provides a charging module; the charging module is used for the battery charging case, and the charging module comprises a charging compartment, a charging clamping structure, and a first drive assembly; the charging compartment comprises a compartment body and a first bracket, and the first bracket is installed in the chamber of the compartment body and comprises a battery installation through slot for accommodating the batteries to be charged; the charging clamping structure is installed on the first bracket corresponding to battery installation through slot, the first drive assembly is drivingly connected to the charging clamping structure and is configured to move along the width direction of battery charging case, and drive the charging clamping structure to move along the length direction of battery charging case, so as to clamp and charge the batteries to be charged.

In the second aspect, the embodiment of the present application provides a battery charging case; the battery charging case comprises a feeding module, a discharging module, and the aforementioned charging module, and the feeding module is used to accommodate the batteries to be charged, while the discharging module is used to accommodate fully charged batteries; the discharging port of feeding module is connected to the feeding port of compartment body, and the discharging port of compartment body is connected to the feeding port of discharging module.

Based on the charging module and battery charging case in the embodiments of the present application, a first drive assembly and a charging clamping structure are designed. The first drive assembly moves along the width direction of battery charging case to drive the charging clamping structure to move along the length direction of battery charging case, so that the charging clamping structure clamps the batteries to be charged while electrical conductivity is maintained between the charging clamping structure and the electrodes of the batteries to be charged to charge the batteries to be charged; the charging clamping structure can effectively clamp and fix the batteries to be charged, avoiding ineffective charging caused by the loosening of the batteries to be charged, and also facilitating battery charging for the charging clamping structure.

### BRIEF DESCRIPTION OF DRAWINGS

In order to provide a clearer explanation of the technical solution of the embodiments of the present application, the accompanying drawings required for the description of the embodiments will be briefly introduced below. Obviously, the accompanying drawings described below are some embodiments of the present invention, and those of ordinary skill in the art can also obtain other drawings based on these ones without creative labor.

FIG. 1 is a structure diagram of a cross-section of a charging module in one embodiment of the present application;

FIG. 2 is a structure diagram of the charging clamping structure and the first drive assembly installed on the first bracket in one embodiment of the present application;

FIG. 3 is a structure diagram of the charging clamping structure and the first drive assembly in one embodiment of the present application;

FIG. 4 is a structure diagram of FIG. 3 from another perspective;

FIG. 5 is an exploded structure diagram of the clamping assembly, charging assembly, and first drive assembly in one embodiment of the present application;

FIG. 6 is a schematic top view of FIG. 3;

FIG. 7 is a schematic bottom view of FIG. 3;

FIG. 8 is a structure diagram of the first drive assembly installed on the first bracket in one embodiment of the present application;

FIG. 9 is a structure diagram of a battery charging case in one embodiment of the present application.

Marks in the attached drawings: 1. Battery charging case; XX′, length direction; YY′, width direction; ZZ′, height direction; 10. Feeding module; 11. Feeding compartment; 20. Charging module; 21. Charging compartment; 211. Compartment body; 212. First bracket; 212a. Battery installation through slot; 212b. First perforation; 212c. Limit hole; 22. Clamping assembly; 221. gripper; 221a. Second perforation; 221b. Groove; 222. Connection unit; 222a. Connection block; 222b. Limit slot; 223. Limit unit; 223a. Limit column; 23. Charging assembly; 231. Charging circuit board; 232. Charging terminal group; 232a. Charging terminal; 24. First drive assembly; 241. Drive bracket; 241a. Drive frame; 241b. Drive block; 241c. Limit protrusion; 242. First motor; 30. Discharging module; 31. Discharging compartment.

### DESCRIPTION OF EMBODIMENTS

In order to make the purpose, technical solution, and advantages of the present application clearer and more understandable, further detailed explanations of the present application will be provided in conjunction with the accompanying drawings and embodiments. It should be understood that the specific embodiments described herein are only used to explain, rather than limit the present application.

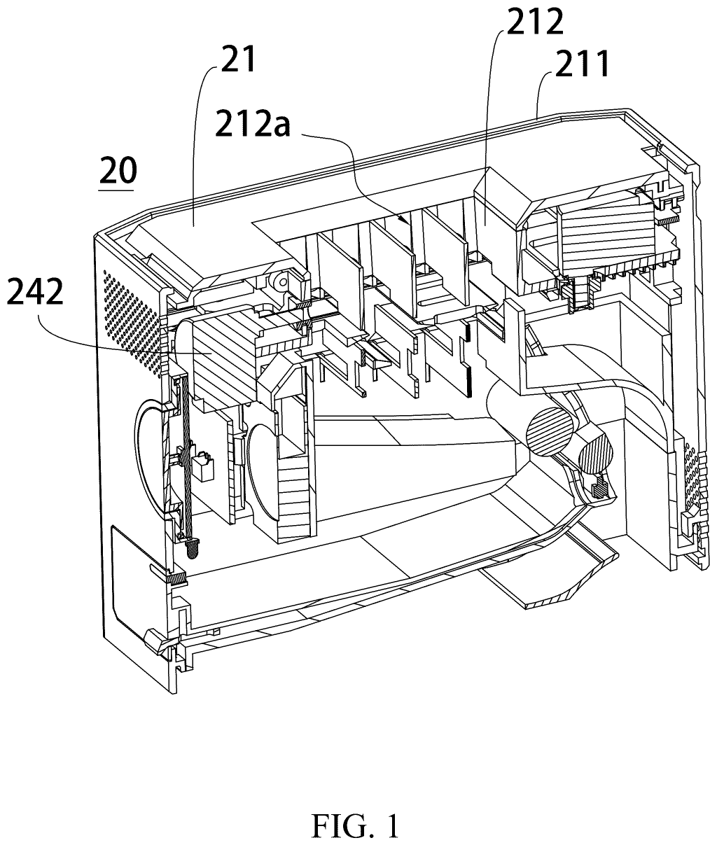

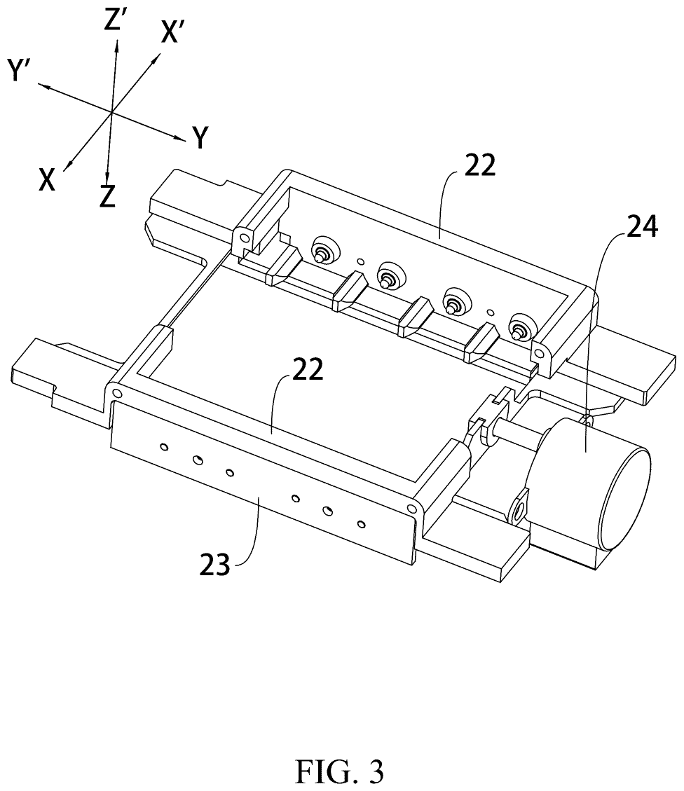

As shown in FIG. 1-4, in the first aspect, the present application proposes a charging module 20 that can effectively charge the batteries to be charged.

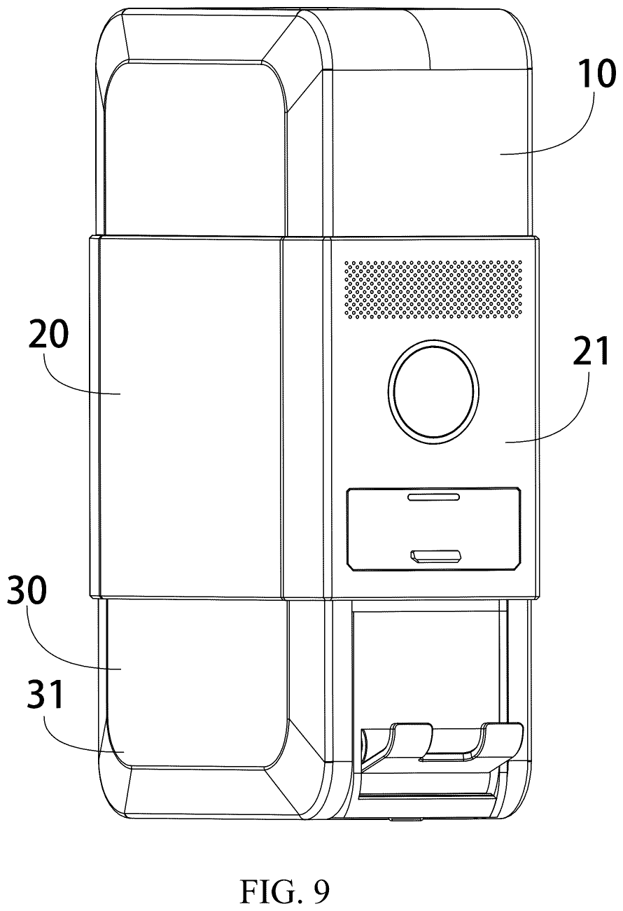

The charging module 20 is used for the battery charging case (as shown in FIG. 9), and the charging module 20 comprises a charging compartment 21, a charging clamping structure, and a first drive assembly 24; the charging compartment 21 comprises a compartment body 211 and a first bracket 212, and the first bracket 212 is installed in the chamber of the compartment body 211 and comprises a battery installation through slot 212a for accommodating the batteries to be charged; the charging clamping structure is installed on the first bracket 212 corresponding to the battery installation through slot 212a, the first drive assembly 24 is drivingly connected to the charging clamping structure and is configured to move along the width direction YY′ of battery charging case 1, and drive the charging clamping structure to move along the length direction XX′ of battery charging case 1, so as to clamp and charge the batteries to be charged.

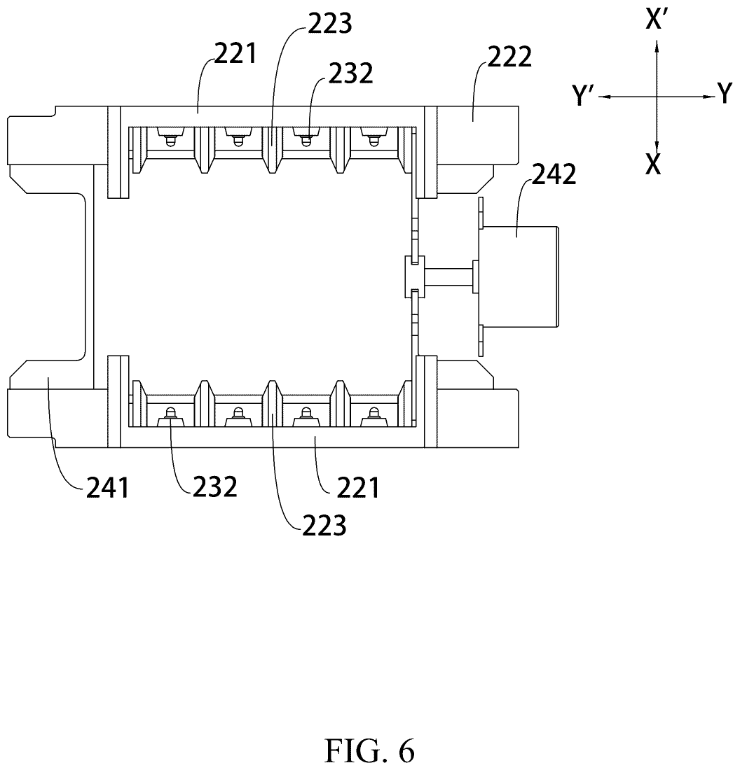

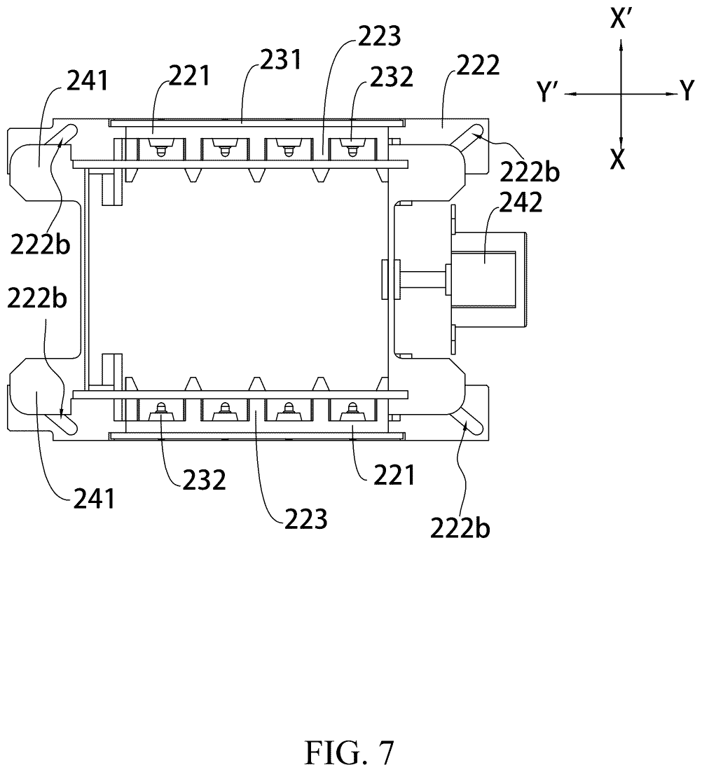

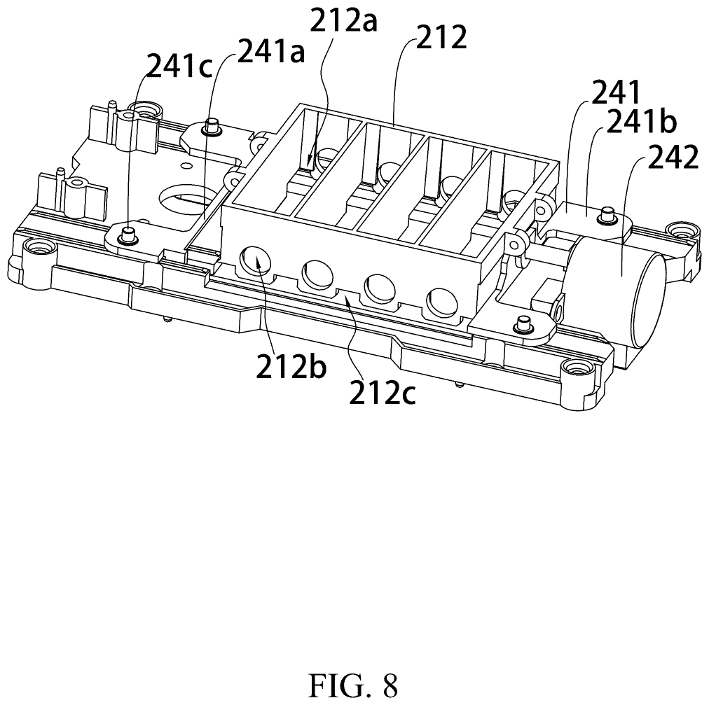

The specific structure of charging module 20 will be described below in conjunction with FIG. 1-8.

As shown in FIG. 1-4, the charging module 20 comprises a charging compartment 21, a charging clamping structure 25, and a first drive assembly 24.

On the one hand, as the outer shell of charging module 20, the charging compartment 21 comprises a compartment body 211, and the outer contour shape of compartment body 211 can be, but is not limited to, a rectangular prism or a cylindrical prism; the specific preparation material of compartment body 211 is not limited here, and designers can make reasonable choices according to actual needs and, for example, the preparation material of compartment body 211 can be, but is not limited to, plastic cement or one of the plastics. Designing the preparation material of compartment body 211 as plastic cement or plastics can effectively reduce the cost of battery charging case 1.

On the other hand, as the bracket of charging module 20, the charging compartment 21 also comprises a first bracket 212; the specific preparation material of the first bracket 212 is not limited here, and designers can make reasonable choices according to actual needs and, for example, the preparation material of the first bracket 212 can be, but is not limited to, plastic cement or one of the plastics.

The first bracket 212 comprises a battery installation through slot 212a for accommodating batteries to be charged; “the battery installation through slot 212a” refers to an area on the first bracket 212 used to place the batteries to be charged; the batteries to be charged that flow out from the discharging port of feeding module 10 (as described below) of battery charging case 1 will directly fall into the battery installation through slot 212a of first bracket 212 after entering the chamber of compartment body 211 through the feeding port of compartment body 211.

The first bracket 212 is installed in the chamber of the compartment body 211, the first bracket 212 and the compartment body 211 can be specifically connected as follows, for example, when the first bracket 212 is detachably connected to the compartment body 211, the first bracket 212 can be fixedly connected to the compartment body 211 through at least one of screw connection, snap-in connection, or plug-in connection and, for example, when the first bracket 212 is not detachably connected to the compartment body 211, the first bracket 212 can be fixedly connected to the compartment body 211 through, but not limited to, adhesive bonding.

As shown in FIG. 1-4, the charging clamping structure serves as, on one hand, a structural component of charging module 20 for charging the batteries to be charged and on the other hand, as a structural component on the first bracket 212 for positioning the batteries to be charged; the specific structure of charging clamping structure will be introduced below.

The charging clamping structure is installed in the first bracket 212 corresponding to battery installation through slot 212a, that is, the charging clamping structure is installed in or near the area where the battery installation through slot 212a of the first bracket 212 is located.

The first drive assembly 24, as a structural component in the charging module 20, is used to provide driving force to drive the charging clamping structure to move along the length direction XX′ of battery charging case 1, thereby clamping or releasing the batteries to be charged; the specific structure of the first drive assembly 24 will be introduced below.

The first drive assembly 24 is drivingly connected to the charging clamping structure to transfer the driving force generated by the first drive assembly 24 to the charging clamping structure. The first drive assembly 24 is configured to move along the width direction YY′ of battery charging case 1, and drive the charging clamping structure to move along the length direction XX′ of battery charging case 1, so as to clamp and charge the batteries to be charged. Understandably, the first drive assembly 24 moves along the width direction YY′ of battery charging case 1 to drive the charging clamping structure to move along the length direction XX′ of battery charging case 1, so that the charging clamping structure clamps the batteries to be charged, while electrical conductivity is maintained between the charging clamping structure and the electrodes of the batteries to be charged to charge the batteries to be charged. When the batteries to be charged are fully charged, the first drive assembly 24 also moves along the width direction YY′ of battery charging case 1 to drive the charging clamping structure to move along the length direction XX′ of battery charging case, such that the charging clamping structure maintains electrical disconnection between the charging clamping structure and the electrodes of fully charged batteries, while releasing the fully charged batteries.

Based on the charging module 20 in the embodiments of the present application, a first drive assembly 24 and a charging clamping structure are designed. The first drive assembly 24 moves along the width direction YY′ of battery charging case 1 to drive the charging clamping structure to move along the length direction XX′ of battery charging case 1, so that the charging clamping structure clamps the batteries to be charged, while electrical conductivity is maintained between the charging clamping structure and the electrodes of the batteries to be charged to charge the batteries to be charged; the charging clamping structure can effectively clamp and fix the batteries to be charged, avoiding ineffective charging caused by the loosening of the batteries to be charged, and also facilitating battery charging for the charging clamping structure.

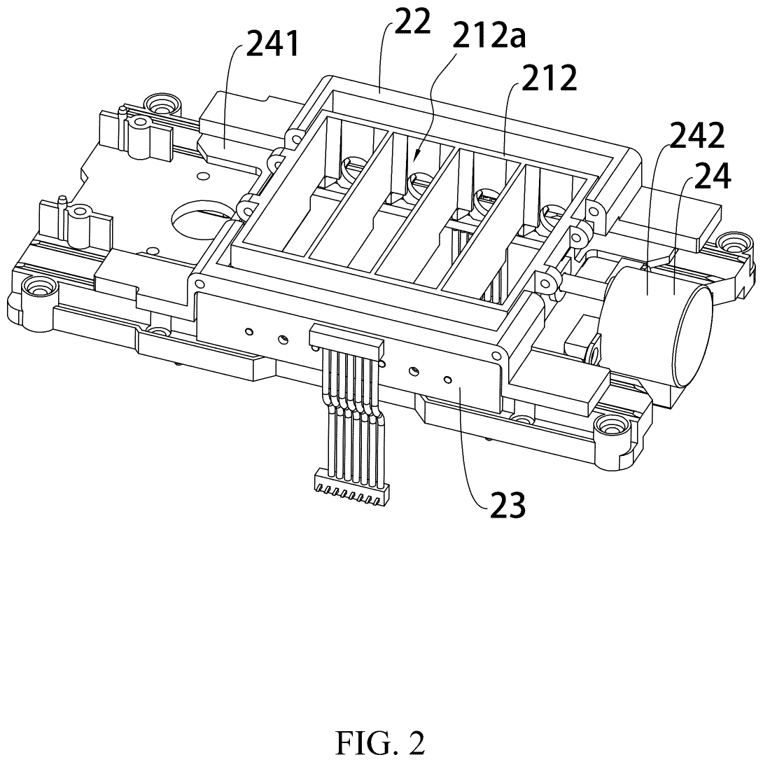

Furthermore, as shown in FIG. 2-5, the charging clamping structure comprises a clamping assembly 22 and a charging assembly 23; the clamping assembly 22 is installed on the first bracket 212 corresponding to battery installation through slot 212a, and is drivingly connected to the first drive assembly 24; the charging assembly 23 is installed on the clamping assembly 22 and comprises a charging terminal for electrical connection with the electrodes of batteries to be charged; the first drive assembly 24 is configured to move along the width direction YY′ of battery charging case 1 to drive the clamping assembly 22 to move along the length direction XX′ of battery charging case 1, such that clamping assembly 22 can clamp the batteries to be charged and maintain contact between the charging terminal of charging assembly 23 and the electrode of batteries to be charged.

The clamping assembly 22 is used, on the one hand, to clamp the batteries to be charged to maintain relative fixation of the position between the batteries to be charged and the first bracket 212 and on the other hand, to release the fully charged battery, so as to make relative position change between the fully charged battery and the first bracket 212; the specific structure of clamping assembly will be introduced below. It should be noted that clamping assembly 22 can be clamped and fixed from one side or from both sides of the batteries to be charged. Charging assembly 23 is used to electrically connect with the electrodes of the batteries to be charged, in order to charge such batteries; the specific structure of charging assembly 23 will be introduced below.

A clamping assembly 22 and a charging assembly 23 are designed, the first drive assembly 24 moves along the width direction YY′ of battery charging case 1 to drive the clamping assembly 22 to move along the length direction XX′ of battery charging case 1, so that the clamping assembly 22 clamps the batteries to be charged, while electrical conductivity is maintained between the clamping assembly 22 and the electrodes of the batteries to be charged to charge the batteries to be charged. When the batteries to be charged are fully charged, the first drive assembly 24 also moves along the width direction YY′ of battery charging case 1 to drive the clamping assembly 22 to move along the length direction XX′ of battery charging case 1, such that the clamping assembly 22 maintains electrical disconnection between the charging terminal of charging assembly 23 and the electrodes of fully charged batteries, while releasing the fully charged batteries. The charging assembly 23 is disposed on the clamping assembly 22 and, on one hand, facilitates effective contact between the charging terminal of charging assembly 23 and the electrodes of the batteries to be charged while clamping and fixing the batteries to be charged in the clamping assembly 22 and, on the other hand, the charging assembly 23 and clamping assembly 22 are arranged more compact in terms of spatial arrangement, effectively reducing the overall volume of the charging module 20.

Furthermore, as shown in FIG. 2-5, the clamping assembly 22 comprises two grippers 221 and two connection units 222; two grippers 221 are installed on the first bracket 212 corresponding to the battery installation through slot 212a, and the charging assembly 23 is installed on the two grippers 221; two connection units 222 are connected one-to-one with two grippers 221, and the two grippers 221 are respectively drivingly connected to the first drive assembly 24 through the corresponding connection units 222; the first drive assembly 24 is configured to move along the width direction YY′ of battery charging case 1, and through the connection unit 222, drives two grippers 221 to approach each other along the length direction XX′ of battery charging case 1, so that the two grippers 221 clamp the batteries to be charged from both ends and make the charging terminal of charging assembly 23 contact the electrodes of the batteries to be charged.

The two grippers 221 clamp and fix the batteries to be charged from both ends of the batteries to be charged and, for example, the cross-section of the grippers 221 perpendicular to the height direction ZZ′ of battery charging case 1 can be shaped like an “I” or a “half frame”. The connection unit 222 serves as a transmission connection between the grippers 221 and the first drive assembly 24. The specific pattern of the connection unit 222 will be introduced below.

Two grippers 221 and two connection units 222 are designed, each gripper 221 is connected to the first drive assembly 24 through a corresponding connection unit 222, the first drive assembly 24 moves along the width direction YY′ of battery charging case 1 and, through the connection unit 222, drives the two grippers 221 to approach each other along the length direction XX′ of battery charging case 1, then the two grippers 221 move along the length direction XX′ of battery charging case 1 to clamp and fix the two ends of the batteries to be charged, while maintaining electrical connection between the charging terminal of charging assembly 23 and the electrodes of the batteries to be charged. When the batteries to be charged are fully charged, the first drive assembly 24 moves along the width direction YY′ of battery charging case 1 and, through the connection unit 222, drives the two grippers 221 to move away from each other along the length direction XX′ of battery charging case 1, then the two grippers 221 move along the length direction XX′ of battery charging case 1 to the initial position to release the fully charged batteries, while providing electrical disconnection between the charging terminal of charging assembly 23 and the electrodes of fully charged batteries.

Furthermore, as shown in FIG. 2-5, the charging assembly 23 comprises two charging circuit boards 231 that are one-to-one connected to two corresponding grippers 221, two charging terminal groups 232 that serve as charging terminals and are one-to-one electrically connected to the two charging circuit boards 231; one of the charging terminal groups 232 is used to make contact with the positive electrodes of the batteries to be charged, and the other charging terminal group 232 is used to make contact with the negative electrodes of the batteries to be charged.

The charging circuit board 231 can be a rigid circuit board, a flexible circuit board, or a combination of flexible and rigid circuit boards; It should be noted that when the charging circuit board 231 is a flexible circuit board, the charging assembly 23 may also include a reinforcing plate that is disposed on one side of the flexible circuit board to provide support for the flexible circuit board. Each charging circuit board 231 is installed on the corresponding gripper 221a and, for example, when the charging circuit board 231 is detachably connected to the gripper 221, the charging circuit board 231 can be fixedly connected to the gripper 221 through, but not limited to, at least one of screw connection, snap-in connection, or plug-in connection and, for example, when the charging circuit board 231 is not detachably connected to the gripper 221, the charging circuit board 231 can be fixedly connected to the gripper 221 through, but not limited to, adhesive bonding.

Two charging circuit boards 231 and two charging terminal groups 232 are designed, one charging terminal group 232 is electrically connected to the other charging circuit board 231, and the other charging terminal group 232 is electrically connected to the other charging circuit board 231, and the first drive assembly 24 moves along the width direction YY′ of battery charging case 1 and, through the connection unit 222, drives the two grippers 221 to approach each other along the length direction XX′ of battery charging case 1, then the two grippers 221 move along the length direction XX′ of battery charging case 1 to clamp and fix the batteries to be charged from both ends of such batteries, while the electrical connection is maintained between the charging terminal group 232 on one charging circuit board 231 and the positive electrodes of the batteries to be charged, as well as between the charging terminal group 232 on another charging circuit board 231 and the negative electrodes of the batteries to be charged.

Furthermore, as shown in FIG. 2-5, there are multiple battery installation through slots 212a, and the multiple battery installation through slots 212a are arranged along the width direction YY′ of battery charging case 1; the two side plates of the first bracket 212, which are arranged opposite each other along the length direction XX′ of battery charging case 1, are provided with multiple first perforations 212b that correspond one-to-one to the multiple battery installation through slots 212a; the two grippers 221 are located on both sides of the first bracket 212 along the length direction XX′ of battery charging case 1; each of the charging terminal groups 232 includes multiple charging terminals 232a that are equal in number to the multiple battery installation through slots 212a and are electrically connected to the corresponding charging circuit boards 231, and the multiple charging terminals 232a in the same charging terminal group 232 are arranged in one-to-one correspondence with the multiple first perforations 212b.

Multiple battery installation through slots 212a are designed on the first bracket 212 to arrange along the width direction YY′ of battery charging case 1, each battery installation channel is embedded with a battery to be charged, the first drive assembly 24 moves along the width direction YY′ of battery charging case 1 and, through the connecting unit 222, drives the two grippers 221 to approach each other along the length direction XX′ of battery charging case 1, then the two grippers 221 move along the length direction XX′ of battery charging case 1 to clamp and fix the multiple batteries to be charged from both ends of such batteries, and multiple charging terminals 232 in the charging terminal group 232 on one of the charging circuit boards 231 run through the corresponding first perforation 212b and keep contact with the positive electrode of the batteries to be charged, and multiple charging terminals 232a in the charging terminal group 232 on the other charging circuit board 231 run through corresponding first holes 212b and keep contact with the negative electrode of the batteries to be charged, such that multiple batteries to be charged in the installation through slots 212a can be charged at once, effectively improving the charging efficiency of the charging module 20.

Furthermore, as shown in FIG. 2-5, each gripper 221 is provided with multiple second perforations 221a equal in number to the multiple battery installation through slots 212a; the two charging circuit boards 231 are both located on the side of the corresponding gripper 221 facing away from the first bracket 212, and the multiple charging terminals 232a of charging terminal group 232 on the same charging circuit board 231 correspond one-to-one to the multiple second perforations 221a on the corresponding gripper 221. The side of the gripper 221 facing away from the first bracket 212 is designed with a groove 221b, and the charging circuit board 231 is embedded in the groove 221b. The charging circuit board 231 designed on the side of the gripper 221 away from the first bracket 212 is separated from the batteries to be charged, thus effectively reducing the possibility of charging circuit board 231 overheat caused by the heat emitted during battery charging that is directly transmitted to the charging circuit board 231, while also reducing the possibility of battery overheat caused by the heat emitted by charging circuit board 231 during operation that is directly transmitted to the batteries. A second perforation 221a is designed on the gripper 221, multiple charging terminals 232a in the charging terminal group 232 on the charging circuit board 231 can pass through the second perforation 221a to expose the side of the gripper 221 facing the first bracket 212, such that effective contact can be maintained between the multiple charging terminals 232a in the charging terminal group 232 and the electrodes of multiple batteries to be charged, thereby effectively charging the multiple batteries to be charged.

Furthermore, as shown in FIG. 2-5, the drive assembly comprises a drive bracket 241 and a first motor 242; Drive bracket 241 is drivingly connected to two connection units 222; the first motor 242 is installed on the first bracket 212, and the drive shaft of the first motor 242 is connected to the drive bracket 241; the first motor 242 is configured to drive the drive bracket 241 to move along the width direction YY′ of battery charging case 1 and to drive the two connection units 222 to move, thereby driving the two grippers 221 to approach each other along the length direction XX′ of battery charging case 1.

The first motor 242 is a stepper motor, and drives the drive bracket 241 to perform linear reciprocating motion in the first direction. The specific model of the first motor 242 is not limited here, and designers can make reasonable choices according to actual needs. The specific connection between the first motor 242 and the first bracket 212/drive bracket 241 can be as follows and, for example, when the first motor 242 is detachably connected to the first bracket 212/drive bracket 241, the first motor 242 can be fixedly connected to the first bracket 212/drive bracket 241 through, but not limited to, screw connection, snap-in connection, or plug-in connection and, for example, when the first motor 242 is not detachably connected to the first bracket 212/drive bracket 241, the first motor 212 can be fixedly connected to the first bracket 212/drive bracket 241 through, but not limited to, adhesive bonding.

A first motor 242 and a drive bracket 241 are designed, the first motor 242 drives the drive bracket 241 connected to the drive shaft to perform linear motion along the width direction YY′ of battery charging case 1, the drive bracket 241 moves along the width direction YY′ of battery charging case 1 and, through the connection unit 222, drives the two grippers 221 to approach each other along the length direction XX′ of battery charging case 1, then the two grippers 221 move along the length direction XX′ of battery charging case 1 to clamp and fix the two ends of the batteries to be charged, while maintaining electrical connection between the charging terminal of charging assembly 23 and the electrodes of the batteries to be charged. When the batteries to be charged are fully charged, the first motor 242 drives the drive bracket 241 connected to the drive shaft to make linear motion along the width direction YY′ of battery charging case 1, and the drive bracket 241 moves along the width direction YY′ of battery charging case 1 and, through the connection unit 222, drives the two grippers 221 to be away from each other along the length direction XX′ of battery charging case 1, then the two grippers 221 move along the length direction XX′ of battery charging case 1 to the initial position to release the fully charged batteries, while maintaining electrical disconnection between the charging terminal of charging assembly 23 and the electrodes of the fully charged batteries.

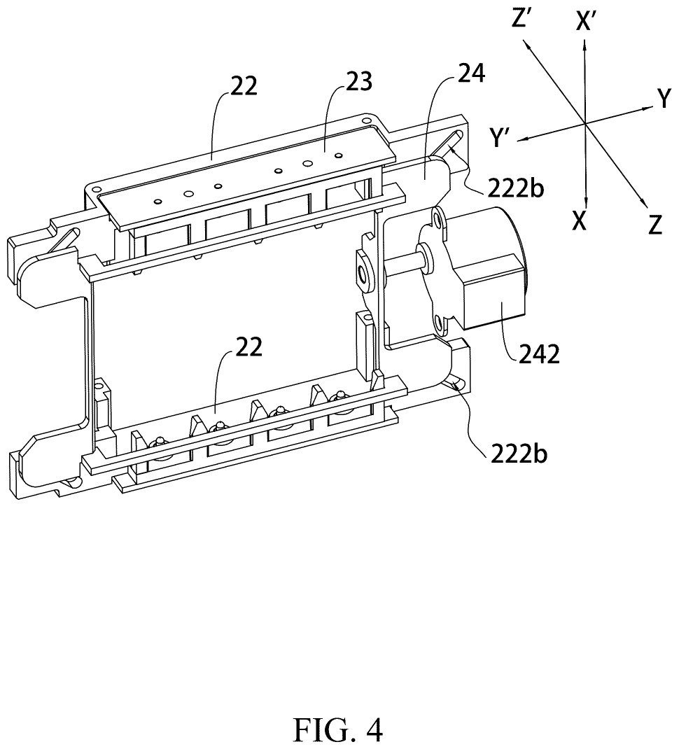

Furthermore, as shown in FIG. 4-7, each of the connection units 222 comprises two connection blocks 222a, and the two connection blocks 222a of the same connection unit 222 are distributed on both sides of the gripper 221 along the width direction YY′ of battery charging case 1 and fixedly connected to the gripper 221, and the bottom surface of each connection block 222a is provided with a limited groove 222b. The drive bracket 241 comprises a drive frame 241a and four drive blocks 241b, and the drive frame 241a is arranged around the periphery of battery installation through slot 212a, and the four drive blocks 241b are located at the four corners of drive frame 241a and fixedly connected to the drive frame 241a, and the top surface of each drive block 241b is provided with a limit protrusion 241c; the drive shaft of the first motor 242 is connected to the drive frame 241a, and the limit protrusion 241c extends into the limit groove 222b and contacts the groove wall of limit groove 222b.

The specific connection between the first connection block 222a and the gripper 221 can be as follows and, for example, when the connection block 222a is detachably connected to the gripper 221, the connection block 222a can be fixedly connected to the gripper 221 through, but not limited to, screw connection, snap-in connection, or plug-in connection and, for example, when the connection block 222a is not detachably connected to the gripper 221, the first motor 212 can be fixedly connected to the gripper 221 through, but not limited to, adhesive bonding. The specific connection between the drive block 241b and the drive frame 241a can be as follows and, for example, when the drive block 241b is detachably connected to the drive frame 241a, the drive block 241b can be fixedly connected to the drive frame 241a through, but not limited to, screw connection, snap-in connection, or plug-in connection and, for example, when the drive block 241b is not detachably connected to the drive frame 241a, the drive block 241b can be fixedly connected to the drive frame 241a through, but not limited to, adhesive bonding. The limit groove 222b is a rectangular groove 221b, and the extension direction of limit groove 222b comprises a first component along the length direction XX′ of battery charging case 1 and a second component along the width direction YY′ of battery charging case 1. The limit protrusion 241c can be integrated with the drive block 241b through, but is not limited to, injection molding or 3D printing.

A connection block 222a and a drive block 241b are designed, the transmission connection between connection block 222a and drive block 241b is realized through the cooperation of limit groove 222b and the limit protrusion 241c, so that when the first motor 242 drives the drive bracket 241 to perform linear motion along the width direction YY′ of battery charging case 1, and under the mutual restriction of groove wall surface of limit groove 222b and the limit protrusion 241c, the two grippers 221 can, under the driving of drive bracket 241, only perform linear motion along the length direction XX′ of battery charging case 1 and clamp and fix the batteries to be charged from both ends of such batteries.

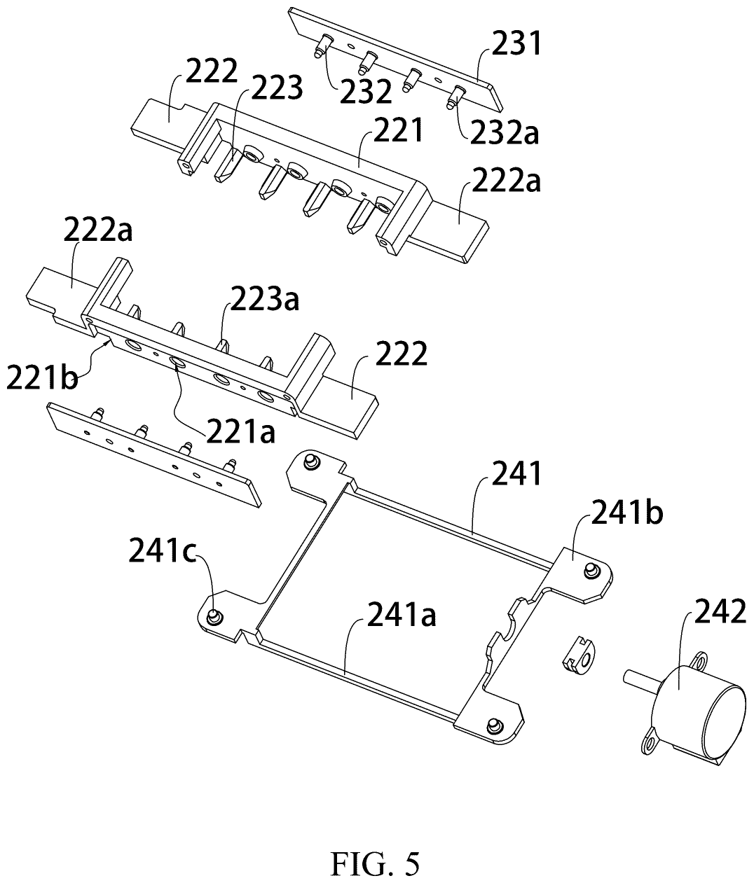

Specifically, as shown in FIG. 5, the drive frame 241a is integrally formed with four drive blocks 241b and, for example, the drive frame 241a can be integrated with four drive blocks 241b through, but not limited to, injection molding or 3D printing, effectively reducing the processing difficulty between the drive frame 241a and the four drive blocks 241b.

Specifically, as shown in FIG. 5, the gripper 221 is integrally formed with four connection blocks 222a and, for example, the gripper 221 can be integrally formed with four connection blocks 222a through, but not limited to, injection molding or 3D printing, effectively reducing the processing difficulty between the gripper 221 and the four connection blocks 222a.

Furthermore, as shown in FIGS. 2, 5, and 8, the two side plates of the first bracket 212 that are arranged opposite each other along the length direction XX′ of battery charging case 1 are also provided with limit holes 212c that are connected to the battery installation through slot 212a; the clamping assembly 22 further comprises two limit units 223 that are connected one-to-one with the two grippers 221, and the limit units 223 are provided with limit holes 212c and are in contact with the hole walls of the limit holes 212c to make grippers 221 move deviated from the length direction of battery charging case 1. In this design, limit units 223 are designed on both grippers 221, and the limit units 223 run through corresponding limit holes 212c, the wall of limit holes 212c restricts the limit units 223, so that the two grippers 221 connected to the two limit units 223 can only perform linear motion along the length direction XX′ of battery charging case 1, ensuring that the two grippers 221 reliably clamps and fixes the batteries to be charged from both ends of such batteries.

Specifically, there are multiple limit holes 212c, and the multiple limit holes 212c are arranged at intervals along the width direction YY′ of battery charging case; each of the limit units comprises multiple limit columns 223a equal to the number of limit holes 212c, the multiple limit columns 223a are disposed on one side of the gripper 221 facing the first bracket 212, and the multiple limit columns 223a run one-to-one through the multiple limit holes. The limit column 223a can be integrated with the gripper 221 through, but not limited to, injection molding or 3D printing. In this design, multiple limit holes 212c are designed on the gripper 221 to arrange at intervals along the width direction YY′ of battery charging case 1, and the limit unit 223 is designed as multiple limit columns 223a corresponding to each limit hole 212c, and the hole walls of each limit hole 212c limit the corresponding limit column 223a, so that the two grippers 221 connected to the multiple limit columns 223a can only perform linear motion along the length direction XX′ of battery charging case 1, ensuring that two grippers 221 reliably clamp and fix the batteries to be charged from both ends of such batteries, and improving the stability of the two grippers 221 during the movement along the length direction XX′ of battery charging case 1.

As shown in FIG. 9, in the second aspect, the present application proposes a battery charging case 1, and the battery charging case 1 comprises a feeding module 10 used to accommodate batteries to be charged, a discharging module 30 used to accommodate the fully charged batteries, and an above-mentioned charging module 20; the discharging port of feeding module 10 is connected to the feeding port of compartment body 211, and the discharging port of compartment body 211 is connected to the feeding port of discharging module 30.

External batteries to be charged flow into the chamber of feeding compartment 11 of the feeding module 10 from the feeding port of feeding module 10, and are effectively stored in the feeding compartment 11 of the feeding module 10. The batteries to be charged stored in the feeding compartment 11 of feeding module 10 flow out of the discharging port of feeding module 10 and, from the feeding port of feeding module 10, into the chamber of feeding compartment 11 of feeding module 10, the batteries to be charged directly fall into the battery installation slot 212a, and the first motor 242 drives the drive frame 241a to move along the width direction YY′ of battery charging case 1, and the drive frame 241a moves to drive the two grippers 221 to approach each other along the length direction XX′ of battery charging case 1 and clamp and fix the batteries to be charged from both ends of such batteries, meanwhile, the charging terminal 232a on the charging circuit board 231 contacts the electrodes of the batteries to be charged, charging the batteries to be charged; When the batteries to be charged are fully charged, the first motor 242 drives the drive frame 241a to move along the width direction YY′ of battery charging case 1, the drive frame 241a drives the two grippers 221 to move away from each other along the length direction XX′ of battery charging case 1 to release the fully charged batteries, and the fully charged batteries flow out of the discharging port of compartment body 211 under own gravity and enter the chamber of discharging compartment 31 of discharge module 30 through the feeding port of discharging module 30, and the discharging compartment 31 of the discharge module 30 can effectively store the fully charged batteries.

The above are only the preferred embodiments of the present application, and are not intended to limit the present application. Any modifications, equivalent substitutions, and improvements made within the spirit and principles of the present application shall be included within the scope of protection hereof.

What is claimed is:

1. A charging module used for a battery charging case, wherein the charging module comprises:
a charging compartment, comprising a compartment body and a first bracket, and the first bracket is installed in a chamber of the compartment body and comprises a battery installation through slot for accommodating the batteries to be charged;
a charging clamping structure, installed on the first bracket corresponding to the battery installation through slot,
a first drive assembly which is drivingly connected to the charging clamping structure, and is configured to move along a width direction of the battery charging case to drive the charging clamping structure to move along the length direction of the battery charging case, so as to clamp and charge the batteries to be charged.

2. The charging module of claim 1, wherein the charging clamping structure comprises:
a clamping assembly that is installed on the first bracket corresponding to the battery installation through slot and is drivingly connected to the first drive assembly;
a charging assembly that is installed on the clamping assembly and comprises a charging terminal for electrical connection with the electrodes of the batteries to be charged;
wherein the first drive assembly is configured to move along the width direction of the battery charging case to drive the clamping assembly to move along the length direction of the battery charging case, such that the clamping assembly clamps the batteries to be charged and maintains contact between the charging terminal of the charging assembly and the electrodes of the batteries to be charged.

3. The charging module of claim 2, wherein the clamping assembly comprises:
two grippers that are installed on the first bracket corresponding to the battery installation through slot, and the charging assembly is installed on the two grippers;
two connection units that are connected individually with two grippers, and the two grippers are respectively drivingly connected to the first drive assembly through the corresponding connection units;
wherein the first drive assembly is configured to move along the width direction of the battery charging case, and through the connection unit, and drive two grippers to approach each other along the length direction of the battery charging case, so that the two grippers clamp the batteries to be charged from both ends and make the charging terminal of the charging assembly contact the electrodes of the batteries to be charged.

4. The charging module of claim 3, wherein the charging assembly comprises:
two charging circuit boards that are connected individually to two corresponding grippers;
two charging terminal groups that serve as charging terminals and are electrically connected individually to the two charging circuit boards;
wherein one of the charging terminal groups is used to make contact with the positive electrodes of the batteries to be charged, and the other charging terminal group is used to make contact with the negative electrodes of the batteries to be charged.

5. The charging module of claim 4, wherein:
there are multiple battery installation through slots, and the multiple battery installation through slots are arranged along the width direction of the battery charging case; the two side plates of the first bracket, which are arranged opposite each other along the length direction of the battery charging case, are provided with multiple first perforations that correspond to the multiple battery installation through slots individually;
the two grippers are located on both sides of the first bracket along the length direction of the battery charging case; each of the charging terminal groups comprises multiple charging terminals that are equal in number to the multiple battery installation through slots and are electrically connected to the corresponding charging circuit boards, and the multiple charging terminals in the same charging terminal group are arranged individually in correspondence with the multiple first perforations.

6. The charging module of claim 5, wherein:
each gripper is provided with multiple second perforations equal in number to the multiple battery installation through slots;
the two charging circuit boards are both located on the side of the corresponding gripper facing away from the first bracket, and the multiple charging terminals on the same charging circuit board correspond individually to the multiple second perforations on the corresponding gripper.

7. The charging module of claim 3, wherein the drive assembly comprises:
a drive bracket, drivingly connected to two connection units;
a first motor installed on the first bracket, and a drive shaft of the first motor is connected to the drive bracket;
wherein the first motor is configured to drive the drive bracket to move along the width direction of the battery charging case, so as to drive the two connection units and the two grippers to approach each other along the length direction of the battery charging case.

8. The charging module of claim 7, wherein each of the connection units comprises two connection blocks, and the two connection blocks of the same connection unit are distributed on both sides of the gripper along the width direction of the battery charging case and fixedly connected to the gripper, and the bottom surface of each connection block is provided with a limited groove;
the drive bracket comprises a drive frame and four drive blocks, and the drive frame is arranged around the periphery of the battery installation through slot, and the four drive blocks are located at the four corners of the drive frame and fixedly connected to the drive frame, and the top surface of each drive block is provided with a limit protrusion;
the drive shaft of the first motor is connected to the drive frame, and the limit protrusion extends into the limit groove and contacts the groove wall of the limit groove.

9. The charging module of claim 8, wherein the drive frame is integrally formed with four drive blocks.

10. The charging module of claim 8, wherein the gripper is integrally formed with four connection blocks.

11. The charging module of claim 3, wherein the two side plates of the first bracket which are arranged opposite each other along the length direction of the battery charging case are also provided with limit holes that are connected to the battery installation through slot;
the clamping assembly further comprises two limit units that are connected individually with the two grippers, and the limit units are provided with limit holes and are in contact with the hole walls of the limit holes to make grippers move deviated from the length direction of the battery charging case.

12. The charging module of claim 11, wherein there are multiple limit holes, and the multiple limit holes are arranged at intervals along the width direction of the battery charging case;
each of the limit units comprises multiple limit columns equal to the number of the limit holes, the multiple limit columns are arranged on one side of the gripper facing the first bracket, and the multiple limit columns are correspondingly threaded through the multiple limit holes.

13. A battery charging case, comprising:
a feeding module used to accommodate batteries to be charged;
the charging module of claim 1;
a discharging module used to accommodate the fully charged batteries;
the discharging port of the feeding module is connected to the feeding port of the compartment body, and the discharging port of the compartment body is connected to the feeding port of the discharging module.
